(19) United States
(12) Patent Application Publication
(10) Pub. No.: US 2017/0213000 A1
(43) Pub. Date: Jul. 27, 2017

(54) METABOLIC MASS SPECTROMETRY SCREENING METHOD FOR DISEASES BASED ON DEEP LEARNING AND THE SYSTEM THEREOF

(71) Applicants: ZHEN JI, Shenzhen (CN); JIARUI ZHOU, Shenzhen (CN); FU YIN, Shenzhen (CN); ZEXUAN ZHU, Shenzhen (CN); SHENZHEN UNIVERSITY, Shenzhen (CN)

(72) Inventors: ZHEN JI, Shenzhen (CN); JIARUI ZHOU, Shenzhen (CN); FU YIN, Shenzhen (CN); ZEXUAN ZHU, Shenzhen (CN)

(73) Assignee: SHENZHEN UNIVERSITY

(21) Appl. No.: 15/198,609

(22) Filed: Jun. 30, 2016

(30) Foreign Application Priority Data
Jan. 25, 2016 (CN) 2016-10049879.8

(51) Int. Cl. G06F 19/00; G06N 3/04; G06N 3/08

(52) U.S. Cl. CPC G06F 19/345; G06N 3/08; G06N 3/04

(57) ABSTRACT

The present invention discloses a metabolic mass spectrometry screening method for diseases based on deep learning and the system thereof. The present invention is based on the prior metabolic mass spectrometry database, and by extracting and integrating specific types of metabolic mass spectrometry samples (such as a disease), which are applied to train a deep learning network, and make it be able to determinate a plurality of types or states simultaneously. Then applying the specific network into screening a real input metabolic mass spectrometry.

### CROSS-REFERENCES TO RELATED APPLICATIONS

This application claims the priority of Chinese patent application no. 201610049879.8, filed on Jan. 25, 2016, the entire contents of all of which are incorporated herein by reference.

### FIELD OF THE INVENTION

The present invention relates to the field of metabolic mass spectrometry screening, and more particularly, to a metabolic mass spectrometry screening method for diseases based on deep learning and the system thereof.

### BACKGROUND

Metabolite is a general term of all small molecular organic compounds that completes metabolic processes in vivo, which contains a wealth of information about the physiological states. Metabolomics is based on a systematic study of metabolites as a whole, which may reveal a real mechanism behind a physiological phenomenon effectively, and may demonstrate a more complete dynamic state of a living body. Therefore, it has received more and more attentions, and has been widely applied to many scientific research and application fields. Mass spectrometry (MS) is one of the most important study tools for metabolomics, it may identify different metabolic substances effectively, and measure their relative concentrations exactly. Its data format is shown in FIG. 1 and FIG. 2. Diseases detection is one of the main application areas of metabolic MS. By measuring quantitatively the presences and abundance changes of targeted metabolites, it is possible to obtain richer and more complete physiological data than a traditional method, before making an effective judgment to the presence and development states of a disease, and finally helps doctors develop targeted treatment protocols.

The existing detection algorithms based on metabolic MS (such as those used in diseases detection or prediction), wherein, the processes contain three major steps: 1), Peak detection, the original MS is pretreated to eliminate noise interferences, and obtain a valid peak. Commonly used pretreatment algorithms include standardization, PCA whitening, ZCA whitening and more; 2) Peak annotation, determines the species of the specific metabolites corresponding to the targeted peak (group). This process is usually completed manually by lab personnel, however, in recent years, some automatic annotation algorithms have come out based on machine learning (ML) and artificial neural network (ANN) technologies, and have achievedpretty good effects; 3) disease determination, which is based on a biological markers database, through analyzing the appearance, disappearance, or concentration changes of certain metabolites, to predict the possible disease types and development status. The commonly used biological markers databases include the Small Molecule Pathway Database (SMPDB), the Human Metabolome Database (HMDB) and else, while the commonly used decision algorithms include the Support Vector Machine Classifier and else.

A deep learning network is one of the analysis methods at the forefront. It has a forecasting ability much better than a traditional algorithm for complex cognitive problems, and a good generalization performance, which may also determine the status of a plurality of targets simultaneously. It has attracted high attentions in academia and industry, and has been applied into important fields such as computer vision, audio signal recognition and else.

However, the existing detection methods based on metabolic MS have some defects.

First, the existing methods require determination and annotation to MS peaks, to decide the according metabolites species. This process usually requires deep involvements of professionals, although some automatic algorithms such as machine learning and else have been applied here, final determinations and adjustments to annotation results still require manual interferences, which has increased the application costs and difficulties. Additionally, since the current metabolomics acknowledges still have a lot missing, usually only less than a half number of peaks in an MS could be annotated successfully, and their average confidences are still pretty low. Therefore, it is impossible to predict a lot of states effectively.

Secondly, the existing methods require an analysis to the changes of each associated metabolic biomarker for each specific class, before making a rough determination to the states. This process is relatively complicated, and requires a plenty of manual interferences. Also, if some markers are not annotated successfully, or their confidences for annotation are pretty low, or some noise signals are annotated as metabolic markers by mistakes, the accuracy of prediction will be seriously affected.

Thirdly, for each analysis running following the existing methods, only a single state may be determined. While in practical applications, it is often needed to detect a variety of different states. If only one single analysis during each running process is applied, then the time cost required will be pretty high. Therefore, how to design a parallel algorithm to screen a plurality of states simultaneously during a single running process becomes an important problem which needs to be solved urgently.

Therefore, the prior art needs to be improved and developed.

### BRIEF SUMMARY OF THE DISCLOSURE

The technical problems to be solved in the present invention is, aiming at the defects of the prior art, providing a metabolic MS screening method based on deep learning and the system thereof, To solve the problems in the prior art, that the existing metabolic MS detection methods have a complicated process, a low accuracy, a high time cost and other problems.

The technical solution of the present invention to solve the said technical problems is as follows:

A metabolic MS screening method based on deep learning, wherein, it comprises the following steps:

A. obtaining a training samples dataset S={S₁, S₂, . . . Sₙ, . . . , S_{N}}, wherein, Sₙ is anyone in the MS, and Sₙ=[(m₁, i₁), (m₂, i₂), . . . (m_{d}, i_{d}), . . . ], wherein, m_{d} and i_{d} are the mass to charge ratio and the intensity of the d-th spectral line, respectively; the label vector according to the said training samples dataset S is: c={c₁, c₂, . . . , c_{N}};

B. pretreating each MS in S and obtaining a metabolic MS characterized dataset, T={T₁, T₂, . . . , T_{N}};

C. constructing a label collection of C=[C₁, C₂, . . . , C_{N}], when supposing any sample label cₙ=k in the original label vector c, then the according Cₙ is constructed as a K-dimensional vector with all values equal to 0 except for the k-th dimensional value which equals to 1;

D. applying both the pretreated metabolic MS characterized dataset T={T₁, T₂, . . . , T_{N}} and the label collection C to train a deep learning network;

E. constructing a deep learning network structure comprising 1 input layer, 1 output layer, and L hidden layers, wherein, the input layer contains a plurality of nodes with a number 2D, and the output layer contains a plurality of nodes with a number K, for any I-th hidden layer, IεL, supposing that it has a nodes number of P_{I}, and these numbers are satisfying a decreasing relationship, that is, P_{I-1}>P_{I}, and, D is a number of spectral lines with the highest intensity selected from Sₙ;

F. training each hidden layer separately, using a stacked auto-encoder;

G. using a logistic regression as an activation function for the nodes in the output layer, and training the nodes in the output layer one by one;

H. after the training in each layer is done separately, stacking the layers one by one, to compose a metabolic MS screening deep learning network;

I. using a BP algorithm to fine-tune the network parameters of the metabolic MS screening deep learning network in a whole;

J. after the training finished, the metabolic MS screening deep learning network is applied for a parallel detection and screening to the metabolic MS samples.

The said metabolic MS screening method based on deep learning, wherein, in the step J, for a newly input metabolic MS sample S, a pretreatment is applied first to obtain a characterized vector T, then, it is sent to the metabolic MS screening deep learning network to execute a parallel prediction, before a corresponding output state vector is obtained as O.

The said metabolic MS screening method based on deep learning, wherein, the said step B comprises specifically:

B1. selecting D of spectral lines in Sₙ with the highest intensity and generating an MS vector S*ₙ=[(m₁, i₁), (m₂ i₂), . . . , (m_{D}, i_{D})] owning a same dimension, if the original dimension number of Sₙ is smaller than D, then it is made up by adding spectral lines of (0, 0);

B2. extracting an intense vector from S*ₙ as Iₙ=[i₁, i₂, . . . , i_{D}], and standardizing before making the value in each dimension have a zero average and a unit deviation:

$${i}_{d}^{*} = \frac{{i}_{d} - {μ}_{n}}{{δ}_{n}} , {i}_{d} ∈ {I}_{n} ,$$

wherein, μₘ and δₘ are the mean and deviation of Iₙ, respectively;

B3. extracting a mass to charge ratio vector of S*ₙ as Mₙ=[m₁, m₂, . . . , m_{D}] and splicing with the pretreated Iₙ to construct an MS characterized vector Tₙ=[m₁, m₂, . . . , m_{D}, i*₁, i*₂, . . . , i*_{D}], which comprises 2D of characterized values.

The said metabolic MS screening method based on deep learning, wherein, the said step F comprises specifically:

F1. supposing the one currently in training is the first hidden layer, then constructing a 3 layers auto-encoder training network;

F2. using a hyperbolic tangent function as an activation function for both hidden layer and auto-encoder training network output layer, then the nodes in the current hidden layer are output as:

Hₗ=tan h(Wₗ^{h}Hₗ₋₁+Bₗ^{h}),

wherein, W^{h}_{I} is a weight matrix of the hidden layer, B^{h}_{I} is an offset vector of the hidden layer, H_{I-1} is the hidden nodes output from the I-1-th layer,

H_{I-1}=[h_{I-1,1},h_{I-1,2}, . . . ,h_{I-1,PI-1}];

F3. the nodes from the output layer of the auto-encoder training network are output as:

Oₗ=tan h(Wₗ^{o}Hₗ+Bₗ^{o}),

wherein, W^{o}_{I} is a weight matrix of the output layer, B^{o}_{I} is an offset vector of the output layer. The output vector O_{I}=[o_{I,1}, o_{I,2}, . . . , o_{I,PI-1}] also contains P_{I-1} values;

F4. defining a deference cost function as:

$${Ψ}_{l} = \frac{1}{2 {P}_{l - 1}} {( {‖ {H}_{l - 1} - {O}_{l} ‖}_{2} )}^{2} ,$$

wherein, ∥·∥₂ represents a 2-norm of a vector difference, besides, based on I₁-regularization, defining a sparse factor as:

ρₗ=∥Hₗ∥₁;

F5. defining a complete cost function as:

Jₗ=Ψₗ+λμₗ,

wherein, λ is a Lagrange multiplier;

F6. based on the complete cost function, using a back-propagation (BP) algorithm to train the values of W^{h}_{I}, B^{h}_{I}, W^{o}_{I} and B^{o}_{I}, before achieving preferred training results for hidden layers;

F7. updating I=I+1, if I<L, then turning to step F1.

The said metabolic MS screening method based on deep learning, wherein, the said step G comprises specifically:

G1. supposing what the currently training is the k-th node in the output layer, defining a difference cost function as:

$${Ψ}_{k} = - \frac{1}{N} ( {\sum }_{n = 1}^{N} {\sum }_{s = 1}^{S} {1}_{s} ( {O}_{k}^{n} ) log \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ) ,$$

wherein, θ^{s}ₖ is a row vector of the s-th row(s□ S) in the parameter matrix θₖ of the node k in the output layer; S=2 means a total states number expressed by the specific node; bₖ is an offset value; and the function 1ₛ( ) is an indicator function, wherein, Oⁿₖ is an output of the node k in the output layer when an input is H_{L}ⁿ, whose value is calculated as:

$${O}_{k}^{n} = {argmax}_{s ∈ S} \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ,$$

wherein, H_{L}ⁿ is an output of the last hidden layer when it is using a sample Tₙ for training;

G2. defining a sparse factor as a 1-norm of the parameter matrix:

ρₖ=Σₛ₌₁^{S}∥θₖ^{s}∥₁;

G3. defining a complete cost function as:

Jₖ=Ψₖ+λρₖ;

wherein, λ is a Lagrange multiplier;

G4. updating k=k+1, if k<K, then turning to step G1.

A metabolic MS screening system based on deep learning, wherein, it comprises:

a data obtaining module, applied to obtain a training dataset S={S₁, S₂, . . . Sₙ, . . . , S_{N}}, wherein, Sₙ is anyone of the MS, and Sₙ=[(m₁, i₁), (m₂, i₂), . . . (m_{d}, i_{d}), . . . ], wherein, m_{d} and i_{d} are the mass to charge ratio and intensity of the d-th spectral line respectively; the label vector according to the said training samples dataset S is: c={c₁, c₂, . . . , c_{N}};

a pretreatment module, applied to pretreat each MS in S and obtain a metabolic MS characterized dataset, T={T₁, T₂, . . . , T_{N}};

a label collection construction module, applied to construct a label collection of C=[C₁, C₂, . . . , C_{N}], when supposing any sample label cₙ=k in the original label vector c, then the according Cₙ is constructed as a K-dimensional vector with all values equal to 0, except for the k-th dimensional value which equals to 1;

a studying module, applied to use both the pretreated metabolic MS characterized dataset T={T₁, T₂, . . . , T_{N}} and the label collection C to train a deep learning network;

a deep learning network structure construction module, applied to construct a deep learning network structure comprising 1 input layer, 1 output layer, and L hidden layers, wherein, the input layer contains a plurality of nodes with a number of 2D, and the output layer contains a plurality of nodes with a number of K, for any I-th hidden layer, IεL, supposing that, it has a nodes number of P_{I}, and these numbers are satisfying a decreasing relationship, that is, P_{I-1}>P_{I}, and D is the number of spectral lines with the highest intensity selected from Sₙ;

a hidden layer training module, applied to train each hidden layer separately using a stacked auto-encoder;

an output layer training module, applied to use a logistic regression as an activation function of the nodes in the output layer, and train the nodes in the output layer one by one;

a construction module for the metabolic MS screening deep learning network, applied to stack the layers one by one and compose a metabolic MS screening deep learning network, after training each layer separately;

a fine-tuning module, applied to use a BP algorithm to fine-tune the network parameters of the metabolic MS screening deep learning network in a whole;

a detection module, applied to use the metabolic MS screening deep learning network for parallel detection and screening to the metabolic MS samples, after the training finished.

The said metabolic MS screening system based on deep learning, wherein, in the detection module, for a newly input metabolic MS sample S, a pretreatment is applied first to obtain a characterized vector T, then, it is sent to the metabolic MS screening deep learning network to execute a parallel prediction, before a corresponding output state vector is obtained as O.

The said metabolic MS screening system based on deep learning, wherein, the said pretreatment module comprises specifically:

a selection unit, applied to select D of spectral lines in Sₙ with the highest intensity and generate an MS vector S*ₙ=[(m₁, i₁), (m₂, i₂), . . . , (m_{D}, i_{D})] owning a same dimension, if the original dimension number of Sₙ is smaller than D, then it is made up by adding spectral lines of (0, 0);

a standardization unit, applied to extract an intense vector from S*ₙ as Iₙ=[i₁, i₂, . . . , i_{D}], and standardize it, before making the value in each dimension have a zero average and a unit deviation:

$${i}_{d}^{*} = \frac{{i}_{d} - {μ}_{n}}{{δ}_{n}} , {i}_{d} ∈ {I}_{n} ,$$

wherein, μₘ and δₘ are the mean and deviation of Iₙ, respectively;

a splicing unit, applied to extract a mass to charge ratio vector of S*ₙ as Mₙ=[m₁, m₂, . . . , m_{D}] and splice with the pretreated Iₙ, to construct an MS characterized vector Tₙ=[m₁, m₂, . . . , m_{D}, i*₁, i*₂, . . . , i*_{D}], which comprises 2D of characterized values.

The said metabolic MS screening system based on deep learning, wherein, the said hidden layer training module comprises specifically:

a training network construction unit, applied to construct 3 layers of auto-encoder training network, when supposing the one currently in training is the first hidden layer;

a hidden layer nodes output unit, applied to use a hyperbolic tangent function as an activation function for both hidden layer and auto-encoder training network output layer, then the nodes in the current hidden layer are output as:

Hₗ=tan h(Wₗ^{h}Hₗ₋₁+Bₗ^{h}),

wherein, W^{h}_{I} is a weight matrix of the hidden layer, B^{h}_{I} is an offset vector of the hidden layer, H_{I-1} is the hidden nodes output from the I-1-th layer,

H_{I-1}=[h_{I-1,1},h_{I-1,2}, . . . ,h_{I-1,PI-1}];

an output unit for the output layer nodes, applied to output the nodes from the output layer of the auto-encoder training network as:

Oₗ=tan h(Wₗ^{o}Hₗ+Bₗ^{o}),

wherein, W^{o}_{I} is a weight matrix of the output layer, B^{o}_{I} is an offset vector of the output layer. The output vector O_{I}=[o_{I,1}, o_{I,2}, . . . , o_{I,PI-1}] also contains P_{I-1} values;

a first deference cost function definition unit, applied to define a deference cost function as:

$${Ψ}_{l} = \frac{1}{2 {P}_{l - 1}} {( {‖ {H}_{l - 1} - {O}_{l} ‖}_{2} )}^{2} ,$$

wherein, ∥·∥₂ represents a 2-norm of a vector difference, besides, based on I₁ standardization, defining a sparse factor as:

ρₗ=∥Hₗ∥₁;

a complete cost function definition unit, applied to define a complete cost function as:

Jₗ=Ψₗ+λρₗ,

wherein, λ is a Lagrange multiplier;

a hidden layer training unit, applied to use a back-propagation algorithm to train the values of W^{h}_{I}, B^{h}_{I}, W^{o}_{I}, and B^{o}_{I}, and achieve preferred training results for hidden layers, based on the complete cost function;

a first updating unit, applied to update I=I+1, if I<L, then turn to the training network construction unit.

The said metabolic MS screening system based on deep learning, wherein, the said hidden layer training module includes specifically:

a second difference cost function definition unit, when supposing what the currently training is the k-th node in the output layer, the unit is applied to define the difference cost function as:

$${Ψ}_{k} = - \frac{1}{N} ( {\sum }_{n = 1}^{N} {\sum }_{s = 1}^{S} {1}_{s} ( {O}_{k}^{n} ) log \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ) ,$$

wherein, θ^{s}ₖ is a row vector of the s-th row (s□ S) in the parameter matrix θₖ of the node k in the output layer; S=2 means a total states number expressed by the specific node; bₖ is an offset value; and the function 1ₛ( ) is an indicator function, wherein, Oⁿₖ is an output of the node k in the output layer when an input is H_{L}ⁿ, whose value is calculated as:

$${O}_{k}^{n} = {argmax}_{s ∈ S} \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ,$$

wherein, H_{L}ⁿ is an output of the last hidden layer when it is using a sample Tₙ for training;

a norm definition unit, applied to define a sparse factor as a 1-norm of the parameter matrix:

ρₖ=Σₛ₌₁^{S}∥θₖ^{s}∥₁;

a second complete cost function definition unit, applied to define a complete cost function as:

Jₖ=Ψₖ+λρₖ;

wherein, λ is a Lagrange multiplier;

a second updating unit, applied to update k=k+1, if k<K, then turnto the 15 second deference cost function definition unit.

Benefits: first, the present application need not any complicated MS pretreatments and peak detections, it only requires standardizing part of the spectrum lines data with the highest intensity, before sending into the nodes in the input layer of the deep learning network directly. The input data are also not limited to any traditional MS, instead, more advanced MS/MS or NMR spectroscopy may also be applied. This has effectively expanded the application range of the present application, reduced the processing difficulty and cost. Secondly, the present application does not rely on any peak annotations and specific determinations of metabolic markers changing. After the training is completed, no more deep interferences from professional personnel are needed, instead, the said deep learning network may apply automatic analysis directly to the input MS, and screen the states of all targets in parallel. Therefore, the requirements to operators are reduced in practical applications. Additionally, the deep learning network owns a pretty good robust performance, that is, even if the signals of part of the metabolic markers are seriously disturbed or missing, or the interactions between different molecules in the metabolic mixture affect the distributions of the spectrum lines, a pretty exact determination result may still be obtained. Thirdly, although the training to the deep learning network in the present application is pretty hard, and requires a longer time, it is an offline process, which means, only one time executing is required during the system developing procedure. While in the subsequent repeated applications, it is dealt as a deterministic calculation and owning a pretty fast executing speed. Also, a one time running may predict all states of the target, which has improved the screening speed significantly. And the specific value of an output node may be considered as a confidence weight, describing the credibility of the corresponding states of the node.

### BRIEF DESCRIPTION OF THE DRAWINGS

FIG. 1 and FIG. 2 illustrate schematic diagrams of the tandem MS data structure as described in the present application.

FIG. 3 illustrates a flow chart of the metabolic MS screening method based on deep learning as described in the present application.

FIG. 4 illustrates a flow chart of using a stacked auto-encoder to construct and train a deep learning network as described in the present application.

FIG. 5 illustrates an architecture diagram of the auto-encoder training network as described in the present application.

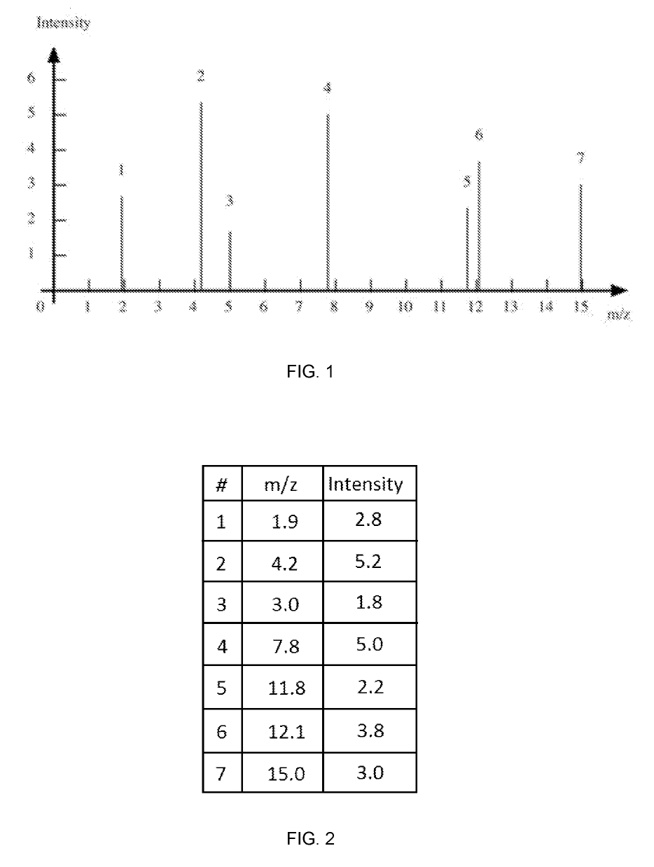

### DETAILED DESCRIPTION

The present invention provides a metabolic MS screening method based on deep learning and the system thereof, In order to make the purpose, technical solution and the advantages of the present invention clearer and more explicit, further detailed descriptions of the present invention are stated here, referencing to the attached drawings and some embodiments of the present invention. It should be understood that the detailed embodiments of the invention described here are used to explain the present invention only, instead of limiting the present invention.

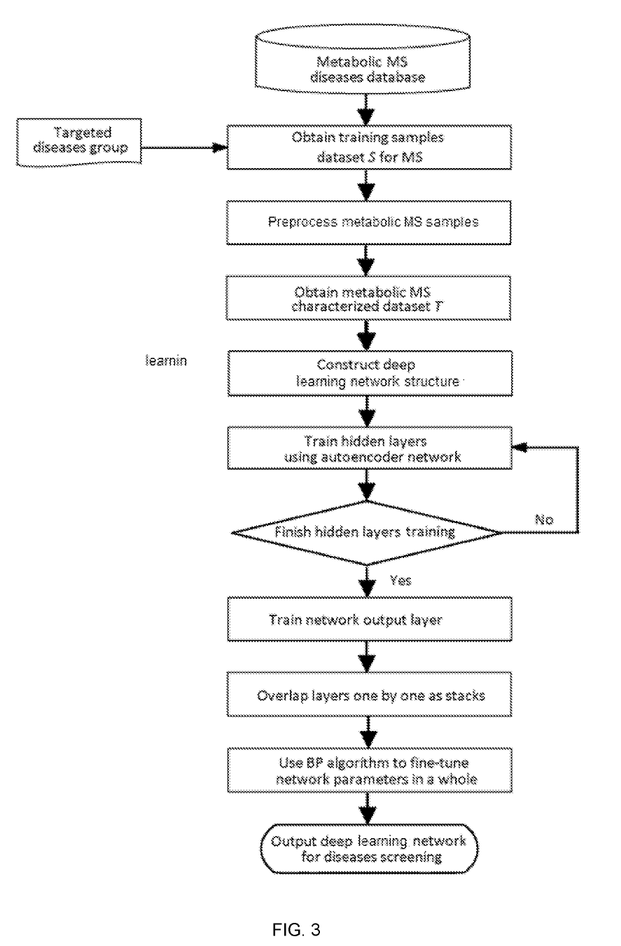

Referencing to FIG. 3, which is a flow chart of the metabolic MS screening method based on deep learning as described in the present application, as shown in the figure, it comprises the following steps:

1). obtaining a training samples dataset S={S₁, S₂, . . . Sₙ, . . . , S_{N}}, wherein, Sₙ is anyone of the MS, and Sₙ=[(m₁, i₁), (m₂, i₂), . . . (m_{d}, i_{d}), . . . ], wherein, m_{d} and i_{d} are the mass to charge ratio and the intensity of the d-th spectral line, respectively; the label vector according to the said training samples dataset S is: c={c₁, c₂, . . . , c_{N}},

2). pretreating each MS in S and obtaining a metabolic MS characterized dataset, T={T₁, T₂, . . . , T_{N}};

3). constructing a label collection of C=[C₁, C₂, . . . , C_{N}], when supposing any sample label cₙ=k in the original label vector c, then the according Cₙ is constructed as a K-dimensional vector with all values equal to 0 except for the k-th dimensional value which equals to 1;

4). Applying both the pretreated metabolic MS characterized dataset T={T₁, T₂, . . . , T_{N}} and the label collection C to train a deep learning network;

5). constructing a deep learning network structure comprising 1 input layer, 1 output layer, and L hidden layers, wherein, the input layer contains a plurality of nodes with a number 2D, and the output layer contains a plurality of nodes with a number K, for any I-th hidden layer, IεL, supposing that it has a nodes number of P_{I}, and these numbers are satisfying a decreasing relationship, that is, P_{I-1}>P_{I}, and, D is the number of spectral lines with the highest intensity selected from Sₙ;

6). training each hidden layer separately, using a stacked auto-encoder;

7). using a logistic regression as an activation function for the nodes in the output layer, and training the nodes in the output layer one by one;

8). after the training in each layer is done separately, stacking all layers one by one, and composing a metabolic MS screening deep learning network;

9). using a BP algorithm to fine-tune the network parameters of the metabolic MS screening deep learning network in a whole;

10). after the training finished, the metabolic MS screening deep learning network is applied for a parallel detection and screening to the metabolic MS samples.

The method of the present invention may be applied to predict the disease states in a targeted group of diseases, however, obviously, it may not be limited to detect this only, instead, it may also be applied to detect other classes of metabolic MS, which means a broader application range.

In the said step 1), when the present invention is applied to detect disease data, assuming it is working for a plurality of diseases included in the targeted diseases group, then by querying the existing databases for metabolic MS, such as MetaboLights, HMBD and else, a training samples dataset S={S₁, S₂, . . . , S_{N})} is integrated and obtained, wherein, for any Sₙ in the MS, Sₙ=[(m₁, i₁), (m₂, i₂), . . . (m_{d}, i_{d}), . . . ], wherein, m_{d} and i_{d} are the mass to charge ratio and the intensity of the d-th spectral line, respectively. The corresponding label vector is c={c₁, c₂, . . . , c_{N}}, wherein, it comprises K+1 labels, i.e., K types of targeted diseases and 1 type of regular sample without diseases.

In the said step 2), pretreating each MS in S, i.e., Sₙ, (the metabolic MS sample), it includes specifically:

a) selecting D of spectral lines in Sₙ owning the highest intensity and generating an MS vector Sₙ*=[(m₁, i₁), (m₂, i₂), . . . (m_{D}, i_{D})] owning a same dimension, if the original dimension number of Sₙ is smaller than D, then it is made up by adding spectral lines of (0, 0);

b) extracting an intense vector from Sₙ* as Iₙ=[i₁, i₂, . . . , i_{D}], and standardizing before making the value in each dimension have a zero average and a unit deviation:

$${i}_{d}^{*} = \frac{{i}_{d} - {μ}_{n}}{{δ}_{n}} , {i}_{d} ∈ {I}_{n} ,$$

wherein, μₘ and δₘ are the mean and deviation of Iₙ, respectively. It should be noted that, those spectral lines of (0,0) added in the step a), in order to make up the same dimension numbers, will not take the calculations described in this step.

c) extracting a mass to charge ratio vector of Sₙ* as Mₙ=[m₁, m₂, . . . , m_{D}] and splicing with the pretreated Iₙ to construct an MS characterized vector Tₙ=[m₁, m₂, . . . , m_{D}, i₁*, i₂*, . . . , i_{D}*], which comprises 2D of characterized values.

In the said step 3), constructing a label collection as C=[C₁, C₂, . . . , C_{N}], when supposing any sample label cₙ=k (diseases) in the original label vector c, then the according Cₙ is constructed as a K-dimensional vector with all values equal to 0 except for the k-th dimensional value which equals to 1. Specifically, for the samples without any diseases, the according Cₙ is constructed as a K-dimensional vector with all values equal to 0.

In the said step 4), applying the pretreated metabolic MS characterized dataset T={T₁, T₂, . . . , T_{N}} and the label collection C to train a deep learning network.

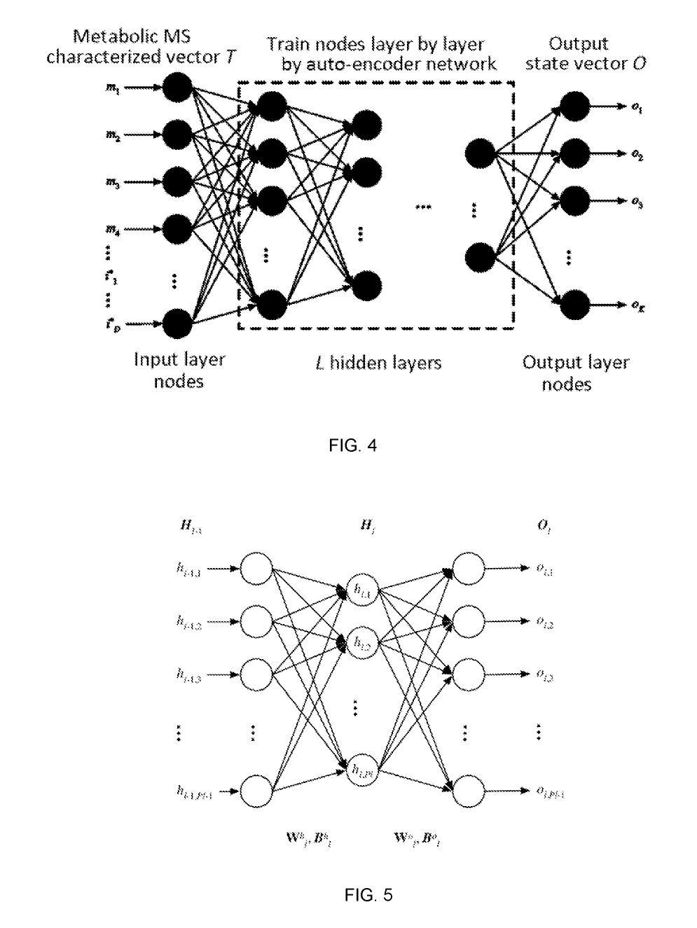

In the said step 5), as shown in FIG. 4, constructing a deep learning network structure comprising 1 input layer, 1 output layer, and L hidden layers, wherein, the input layer contains a plurality of nodes with a number of 2D, and the output layer contains a plurality of nodes with a number of K, for any I-th hidden layer, IεL, supposing that it has a nodes number of P_{I}, and these numbers are satisfying a decreasing relationship, that is, P_{I-1}>P_{I}.

In the said step 6), training each hidden layer separately using a stacked auto-encoder, it comprises specifically:

a) supposing the one currently in training is the first hidden layer, then constructing a 3 layers auto-encoder training network, as shown in FIG. 5.

b) using a hyperbolic tangent function (tan h) as an activation function for both hidden layer and auto-encoder training network output layer, then the nodes in the current hidden layer are output as:

Hₗ=tan h(Wₗ^{h}Hₗ₋₁+Bₗ^{h}),

wherein, W^{h}_{I} is a weight matrix of the hidden layer, B^{h}_{I} is an offset vector of the hidden layer, H_{I-1} is the hidden nodes output from the I-1-th layer,

H_{I-1}=[h_{I-1,1},h_{I-1,2}, . . . ,h_{I-1,PI-1}];

if I=1, the 2D of nodes in the input layer are applied for substitutions, that is, the MS of Tₙ in the metabolic MS characterized dataset T.

c) the nodes from the output layer of the auto-encoder training network are output as:

Oₗ=tan h(Wₗ^{o}Hₗ^{o}+Bₗ^{o}),

wherein, W^{o}_{I}, is a weight matrix of the output layer, B^{o}_{I} is an offset vector of the output layer. The output vector O_{I}=[o_{I,1}, o_{I,2}, . . . , o_{I,PI-1}] also contains P_{I-1} values;

d) defining a deference cost function as:

$${Ψ}_{l} = \frac{1}{2 {P}_{l - 1}} {( {‖ {H}_{l - 1} - {O}_{l} ‖}_{2} )}^{2} ,$$

wherein, ∥·∥₂ represents a 2-norm of a vector difference, besides, based on I₁-regularization, defining a sparse factor as:

ρₗ=∥H₁∥₁;

e) defining a complete cost function as:

Jₗ=Ψₗ+λρₗ,

wherein, λ is a Lagrange multiplier, it may be applied to constrain the level of abstraction of the hidden layer.

f. based on the complete cost function, using a BP algorithm to train the values of W^{h}_{I}, B^{h}_{I}, W^{o}_{I} and B^{o}_{I}, before achieving preferred training results for hidden layers.

g) updating I=I+1, if I<L, then turning to 6).a).

In the said step 7), training the output layer in the deep learning network, using a logistic regression as an activation function for the nodes in the output layer, and training the nodes one by one, the step is:

a) supposing what the currently training is the k-th node in the output layer, the difference cost function is defined as:

$${Ψ}_{k} = - \frac{1}{N} ( {\sum }_{n = 1}^{N} {\sum }_{s = 1}^{S} {1}_{s} ( {O}_{k}^{n} ) log \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ) ,$$

wherein, θ^{s}ₖ is a row vector of the s-th row (s□ S) in the parameter matrix θₖ of the node k in the output layer; S=2 means a total states number expressed by the specific node, such as positive or negative; bₖ is an offset value; and the function 1ₛ( ) is an indicator function, wherein, Oⁿₖ is an output of the node k in the output layer when an input is H_{L}ⁿ, whose value is calculated as:

$${O}_{k}^{n} = {argmax}_{s ∈ S} \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ,$$

wherein, H_{L}ⁿ is an output of the last hidden layer (layer L) when it is using a sample Tₙ for training;

b) defining a sparse factor as a 1-norm of the parameter matrix:

ρₖ=Σₛ₌₁^{S}∥θₖ^{s}∥₁;

c) defining the complete cost function as:

Jₖ=Ψₖ+λρₖ,

wherein, λ is a Lagrange multiplier. Take it as a basis, the preferred weight matrix and offset value of each node in the output layer are designed with the gradient descent method.

d) updating k=k+1, if k<K, then turn to step 7).a).

In the said step 8), after training each layer separately, stacking the layers one by one and composing a metabolic MS screening deep learning network.

In the said step 9), a BP algorithm is applied to fine-tune the network parameters of the metabolic MS screening deep learning network in a whole, in order to further improve the prediction accuracy.

In the said step 10), for a newly input metabolic MS sample S, a pretreatment following the methods of 2).a)-c), is applied first to obtain a characterized vector T, then, it is sent to the metabolic MS screening deep learning network to execute a parallel prediction, before a corresponding output status vector is obtained as O. When it is applied to detect diseases data, wherein, any oₖ=1 represents that a disease k is shown positive, otherwise, it is shown negative. The specific information may act as basic data for subsequent researches and clinical diagnoses and treatments.

Based on the method described above, the present application further provides a metabolic MS screening system based on deep learning, wherein, it comprises:

a data obtaining module, applied to obtain a training dataset S={S₁, S₂, . . . Sₙ, . . . , S_{N}}, wherein, Sₙ is anyone of the MS, and Sₙ=[(m₁, i₁), (m₂, i₂), . . . (m_{d}, i_{d}), . . . ], wherein, m_{d} and i_{d} are the mass to charge ratio and intensity of the d-th spectral line respectively; the label vector according to the said training samples dataset S is: c={c₁, c₂, . . . , c_{N}};

a pretreatment module, applied to pretreat each MS in S and obtain a metabolic MS characterized dataset, T={T₁, T₂, . . . , T_{N}};

a label collection construction module, applied to construct a label collection of C=[C₁, C₂, . . . , C_{N}], when supposing any sample label cₙ=k in the original label vector c, then the according Cₙ is constructed as a K-dimensional vector with all values equal to 0, except for the k-th dimensional value which equals to 1;

a studying module, applied to use both the pretreated metabolic MS characterized dataset T={T₁, T₂, . . . , T_{N}} and the label collection C to train a deep learning network;

a deep learning network structure construction module, applied to construct a deep learning network structure comprising 1 input layer, 1 output layer, and L hidden layers, wherein, the input layer contains a plurality of nodes with a number of 2D, and the output layer contains a plurality of nodes with a number of K, for any I-th hidden layer, IεL, supposing that, it has a nodes number of P_{I}, and these numbers are satisfying a decreasing relationship, that is, P_{I-1}>P_{I}, and D is the number of spectral lines with the highest intensity selected from Sₙ;

a hidden layer training module, applied to train each hidden layer separately using a stacked auto-encoder;

an output layer training module, applied to use a logistic regression as an activation function of the nodes in the output layer, and train the nodes in the output layer one by one;

a construction module for the metabolic MS screening deep learning network, applied to stack the layers one by one and compose a metabolic MS screening deep learning network, after training each layer separately;

a fine-tuning module, applied to use a BP algorithm to fine-tune the network parameters of the metabolic MS screening deep learning network in a whole;

a detection module, applied to use the metabolic MS screening deep learning network for parallel detection and screening to the metabolic MS samples, after the training finished.

Wherein, in the detection module, for a newly input metabolic MS sample S, a pretreatment is applied first to obtain a characterized vector T, then, it is sent to the metabolic MS screening deep learning network to execute a parallel prediction, before a corresponding output state vector is obtained as O.

Wherein, the said pretreatment module comprises specifically:

a selection unit, applied to select D of spectral lines in Sₙ owning the highest intensity and generate an MS vector Sₙ*=[(m₁, i₁), (m₂, i₂), . . . , (m_{D}, i_{D})] owning a same dimension, if the original dimension number of Sₙ is smaller than D, then it is made up by adding spectral lines of (0, 0);

a standardization unit, applied to extract an intense vector from Sₙ* as Iₙ=[i₁, i₂, . . . , i_{D}], and standardize it, before making the value in each dimension have a zero average and a unit deviation:

$${i}_{d}^{*} = \frac{{i}_{d} - {μ}_{n}}{{δ}_{n}} , {i}_{d} ∈ {I}_{n} ,$$

wherein, μₘ and δₘ are the mean and deviation of Iₙ, respectively;

a splicing unit, applied to extract a mass to charge ratio vector of Sₙ* as Mₙ=[m₁, m₂, . . . , m_{D}] and splice with the pretreated Iₙ, to construct an MS characterized vector Tₙ=[m₁, m₂, . . . , m_{D}, i₁*, i₂*, . . . , i_{D}*], which comprises 2D of characterized values.

Wherein, the said hidden layer training module comprises specifically:

a training network construction unit, applied to construct 3 layers of auto-encoder training network, when supposing the one currently in training is the first hidden layer;

a hidden layer nodes output unit, applied to use a hyperbolic tangent function as an activation function for both hidden layer and auto-encoder training network output layer, then the nodes in the current hidden layer are output as:

Hₗ=tan h(Wₗ^{h}Hₗ₋₁+Bₗ^{h}),

wherein, W^{h}_{I} is a weight matrix of the hidden layer, B^{h}_{I} is an offset vector of the hidden layer, H_{I-1} is the hidden nodes output from the I-1-th layer,

H_{I-1}=[h_{I-1,1},h_{I-1,2}, . . . ,h_{I-1,PI-1}];

an output unit for the output layer nodes, applied to output the nodes from the output layer of the auto-encoder training network as:

Oₗ=tan h(Wₗ^{o}Hₗ+Bₗ^{o}),

wherein, W^{o}_{I} is a weight matrix of the output layer, B^{o}_{I} is an offset vector of the output layer. The output vector O_{I}=[o_{I,1}, o_{I,2}, . . . , o_{I,PI-1}] also contains P_{I-1} values;

a first deference cost function definition unit, applied to define a deference cost function as:

$${Ψ}_{l} = \frac{1}{2 {P}_{l - 1}} {( {‖ {H}_{l - 1} - {O}_{l} ‖}_{2} )}^{2} ,$$

wherein, ∥·∥₂ represents a 2-norm of a vector difference, besides, based on I₁ standardization, defining a sparse factor as:

ρₗ=∥Hₗ∥₁;

a complete cost function definition unit, applied to define a complete cost function as:

Jₗ=Ψₗ+λρₗ,

wherein, λ is a Lagrange multiplier;

a hidden layer training unit, applied to use a back-propagation algorithm to train the values of W^{h}_{I}, B^{h}_{I}, W^{o}_{I} and B^{o}_{I}, and achieve preferred training results for hidden layers, based on the complete cost function;

a first updating unit, applied to update I=I+1, if I<L, then turn to the training network construction unit.

Wherein, the said hidden layer training module includes specifically:

a second difference cost function definition unit, when supposing what the currently training is the k-th node in the output layer, the unit is applied to define the difference cost function as:

$${Ψ}_{k} = - \frac{1}{N} ( {\sum }_{n = 1}^{N} {\sum }_{s = 1}^{S} {1}_{s} ( {O}_{k}^{n} ) log \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ) ,$$

wherein, θ^{s}ₖ is a row vector of the s-th row (sεS) in the parameter matrix θₖ of the node k in the output layer; S=2 means a total states number expressed by the specific node; bₖ is an offset value; and the function 1ₛ( ) is an indicator function, wherein, Oⁿₖ is an output of the node k in the output layer when an input is H_{L}ⁿ, whose value is calculated as:

$${O}_{k}^{n} = {argmax}_{s ∈ S} \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ,$$

wherein, H_{L}ⁿ is an output of the last hidden layer when it is using a sample Tₙ for training;

a norm definition unit, applied to define a sparse factor as a 1-norm of the parameter matrix:

ρₖ=Σₛ₌₁^{S}∥θₖ^{s}∥₁;

a second complete cost function definition unit, applied to define a complete cost function as:

Jₖ=Ψₖ+λρₖ;

wherein, λ is a Lagrange multiplier;

a second updating unit, applied to update k=k+1, if k<K, then turn to the second deference cost function definition unit.

Technical details of the above said modular units have been described in details in the methods described before, thus they will not be described in details again.

It should be understood that, the application of the present invention is not limited to the above examples listed. Ordinary technical personnel in this field can improve or change the applications according to the above descriptions, all of these improvements and transforms should belong to the scope of protection in the appended claims of the present invention.

What is claimed is:

1. A metabolic MS screening method based on a deep learning, wherein, it comprises the following steps:
A. obtaining a training samples dataset S={S₁, S₂, . . . Sₙ, . . . , S_{N}}, wherein, Sₙ is anyone of the MS, and Sₙ=[(m₁, i₁), (m₂, i₂), . . . (m_{d}, i_{d}), . . . ], wherein, m_{d} and i_{d} are the mass to charge ratio and the intensity of the d-th spectral line, respectively; the label vector according to the said training samples dataset S is: c={c₁, c₂, . . . , c_{N}},
B. pretreating each MS in S and obtaining a metabolic MS characterized dataset, T={T₁, T₂, . . . , T_{N}};
C. constructing a label collection of C=[C₁, C₂, . . . , C_{N}], when supposing any sample label cₙ=k in the original label vector c, then the according Cₙ is constructed as a K-dimensional vector with all values equal to 0 except for the k-th dimensional value which equals to 1;
D. applying both the pretreated metabolic MS characterized dataset T={T₁, T₂, . . . , T_{N}} and the label collection C to train a deep learning network;
E. constructing a deep learning network structure comprising 1 input layer, 1 output layer, and L hidden layers, wherein, the input layer contains a plurality of nodes with a number 2D, and the output layer contains a plurality of nodes with a number K, for any I-th hidden layer, IεL, supposing that it has a nodes number of P_{I}, and these numbers are satisfying a decreasing relationship, that is, P_{I-1}>P_{I}, and, D is the number of spectral lines with the highest intensity selected from Sₙ;
F. training each hidden layer separately, using a stacked auto-encoder;
G. using a logistic regression as an activation function for the nodes in the output layer, and training the nodes in the output layer one by one;
H. after the training in each layer is done separately, stacking the layers one by one, to compose a metabolic MS screening deep learning network;
I. using a BP algorithm to fine-tune the network parameters of the metabolic MS screening deep learning network in a whole;
J. after the training finished, the metabolic MS screening deep learning network is applied for a parallel detection and screening to the metabolic MS samples.

2. The said metabolic MS screening method based on deep learning according to claim 1, wherein, in the step J, for a newly input metabolic MS sample S, a pretreatment is applied first to obtain a characterized vector T, then, it is sent to the metabolic MS screening deep learning network to execute a parallel prediction, before a corresponding output state vector is obtained as O.

3. The said metabolic MS screening method based on deep learning according to claim 1, wherein, the step B comprises specifically:
B1. selecting D of spectral lines in Sₙ owning the highest intensity and generating an MS vector Sₙ*=[(m₁, i₁), (m₂, i₂), . . . , (m_{D}, i_{D})] owning a same dimension, if the original dimension number of S, is smaller than D, then it is made up by adding spectral lines of (0, 0);
B2. extracting an intense vector from Sₙ* as Iₙ=[i₁, i₂, . . . , i_{D}], and standardizing before making the value in each dimension have a zero average and a unit deviation:
$${i}_{d}^{*} = \frac{{i}_{d} - {μ}_{n}}{{δ}_{n}} , {i}_{d} ∈ {I}_{n} ,$$
wherein, μₘ and δₘ are the mean and deviation of Iₙ, respectively;
B3. extracting a mass to charge ratio vector of Sₙ* as Mₙ=[m₁, m₂, . . . , m_{D}] and splicing with the pretreated Iₙ to construct an MS characterized vector Tₙ=[m₁, m₂, . . . , m_{D}, i₁*, i₂*, . . . , i_{D}*], which comprises 2D of characterized values.

4. The said metabolic MS screening method based on deep learning according to claim 1, wherein, the said step F comprises specifically:
F1. supposing the one currently in training is the first hidden layer, then constructing a 3 layers of auto-encoder training network;
F2. using a hyperbolic tangent function as an activation function for both hidden layer and auto-encoder training network output layer, then the nodes in the current hidden layer are output as:
Hₗ=tan h(Wₗ^{h}Hₗ₋₁+Bₗ^{h}),
wherein, W^{h}_{I} is a weight matrix of the hidden layer, B^{h}_{I} is an offset vector of the hidden layer, H_{I-1} is the hidden nodes output from the I-1-th layer,
H_{I-1}=[h_{I-1,1},h_{I-1,2}, . . . ,h_{I-1,PI-1}];
F3. Outputting the nodes from the output layer of the auto-encoder training network as:
Oₗ=tan h(Wₗ^{o}Hₗ+Bₗ^{o}),
wherein, W^{o}_{I} is a weight matrix of the output layer, B^{o}_{I} is an offset vector of the output layer; the output vector O_{I}=[o_{I,1}, o_{I,2}, . . . , o_{I,PI-1}] also contains P_{I-1} values;
F4. defining a deference cost function as:
$${Ψ}_{l} = \frac{1}{2 {P}_{l - 1}} {( {‖ {H}_{l - 1} - {O}_{l} ‖}_{2} )}^{2} ,$$
wherein, ∥·∥₂ represents a 2-norm of a vector difference, besides, based on I₁ standardization, defining a sparse factor as:
ρₗ=∥Hₗ∥₁;
F5. defining a complete cost function as:
Jₗ=Ψₗ+λρₗ,
wherein, λ is a Lagrange multiplier;
F6. based on the complete cost function, using a back-propagation (BP) algorithm to train the values of W^{h}_{I}, B^{h}_{I}, W^{o}_{I} and B^{o}_{I}, before achieving preferred training result for hidden layers;
F7. updating I=I+1, if I<L, then turning to step F1.

5. The said metabolic MS screening method based on deep learning according to claim 1, wherein, the said step G comprises specifically:
G1. supposing what the currently training is the k-th node in the outputlayer, defining a difference cost function as:
$${Ψ}_{k} = - \frac{1}{n} ( {\sum }_{n = 1}^{N} {\sum }_{s = 1}^{S} {1}_{s} ( {O}_{k}^{n} ) log \frac{exp ( {θ}_{k}^{s} {H}_{L}^{n} + {b}_{k} )}{{\sum }_{s = 1}^{S} exp ( {θ}_{k}^{S} {H}_{L}^{n} + {b}_{k} )} ) ,$$
wherein, θ^{s}ₖ is a row vector of the s-th row (s□ S) in the parameter matrix θₖ of the node k in the output layer; S=2 means a total states number expressed by the specific node; bₖ is an offset value; and the function 1ₛ( ) is an indicator function, wherein, Oⁿₖ is an output of the node k in the output layer when an input is H_{L}ⁿ, whose value is calculated as:
$${O}_{k}^{n} = {argmax}_{s ∈ S} \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ,$$
wherein, H_{L}ⁿ is an output of the last hidden layer when it is using a sample Tₙ for training;
G2. defining a sparse factor as a 1-norm of the parameter matrix:
ρₖ=Σₛ₌₁^{S}∥θₖ^{s}∥₁,
G3. defining a complete cost function as:
Jₖ=Ψₖ+λρₖ;
wherein, λ is a Lagrange multiplier;
G4. updating k=k+1, if k<K, then turning to step G1.

6. A metabolic MS screening system based on deep learning, wherein, it comprises:
a data obtaining module, applied to obtain a training dataset S={S₁, S₂, . . . Sₙ, . . . , S_{N}}, wherein, Sₙ is anyone of the MS, and Sₙ=[(m₁, i₁), (m₂, i₂), . . . (m_{d}, i_{d}), . . . ], wherein, m_{d} and i_{d} are the mass to charge ratio and intensity of the d-th spectral line respectively; the label vector according to the said training samples dataset S is: c={c₁, c₂, . . . , C_{N}};
a pretreatment module, applied to pretreat each MS in S and obtain a metabolic MS characterized dataset, T={T₁, T₂, . . . , T_{N})};
a label collection construction module, applied to construct a label collection of C=[C₁, C₂, . . . , C_{N}], when supposing any sample label cₙ=k in the original label vector c, then the according Cₙ is constructed as a K-dimensional vector with all values equal to 0, except for the k-th dimensional value which equals to 1;
a studying module, applied to use both the pretreated metabolic MS characterized dataset T={T₁, T₂, . . . , T_{N}} and the label collection C to train a deep learning network;
a deep learning network structure construction module, applied to construct a deep learning network structure comprising 1 input layer, 1 output layer, and L hidden layers, wherein, the input layer contains a plurality of nodes with a number of 2D, and the output layer contains a plurality of nodes with a number of K, for any I-th hidden layer, IεL, supposing that, it has a nodes number of P_{I}, and these numbers are satisfying a decreasing relationship, that is, P_{I-1}>P_{I}, and D is the number of spectral lines with the highest intensity selected from Sₙ;
a hidden layer training module, applied to train each hidden layer separately using a stacked auto-encoder;
an output layer training module, applied to use a logistic regression as an activation function of the nodes in the output layer, and train the nodes in the output layer one by one;
a construction module for the metabolic MS screening deep learning network, applied to stack the layers one by one and compose a metabolic MS screening deep learning network, after training each layer separately;
a fine-tuning module, applied to use a BP algorithm to fine-tune the network parameters of the metabolic MS screening deep learning network in a whole;
a detection module, applied to use the metabolic MS screening deep learning network for parallel detection and screening to the metabolic MS samples, after the training finished.

7. The said metabolic MS screening system based on deep learning according to claim 6, wherein, in the detection module, for a newly input metabolic MS sample S, a pretreatment is applied first to obtain a characterized vector T, then, it is sent to the metabolic MS screening deep learning network to execute a parallel prediction, before a corresponding output state vector is obtained as O.

8. The said metabolic MS screening system based on deep learning according to claim 6, wherein, the said pretreatment module comprises specifically:
a selection unit, applied to select D of spectral lines in Sₙ owning the highest intensity and generate an MS vector Sₙ*=[(m₁, i₁), (m₂, i₂), . . . , (m_{D}, i_{D})] owning a same dimension, if the original dimension number of Sₙ is smaller than D, then it is made up by adding spectral lines of (0, 0);
a standardization unit, applied to extract an intense vector from Sₙ* as Iₙ=[i₁, i₂, . . . , i_{D}], and standardize it, before making the value in each dimension have a zero average and a unit deviation:
$${i}_{d}^{*} = \frac{{i}_{d} - {μ}_{n}}{{δ}_{n}} , {i}_{d} ∈ {I}_{n} ,$$
wherein, μₘ and δₘ are the mean and deviation of Iₙ, respectively;
a splicing unit, applied to extract a mass to charge ratio vector of Sₙ* as Mₙ=[m₁, m₂, . . . , m_{D}] and splice with the pretreated Iₙ, to construct an MS characterized vector Tₙ=[m₁, m₂, . . . , m_{D}, i₁*, i₂*, . . . , i_{D}*], which comprises 2D of characterized values.

9. The said metabolic MS screening system based on deep learning according to claim 6, wherein, the said hidden layer training module comprises specifically:
a training network construction unit, applied to construct 3 layers of auto-encoder training network, when supposing the one currently in training is the first hidden layer;
a hidden layer nodes output unit, applied to use a hyperbolic tangent function as an activation function for both hidden layer and auto-encoder training network output layer, then the nodes in the current hidden layer are output as:
Hₗ=tan h(Wₗ^{h}Hₗ₋₁+Bₗ^{h}),
wherein, W^{h}_{I} is a weight matrix of the hidden layer, B^{h}_{I} is an offset vector of the hidden layer, H_{I-1} is the hidden nodes output from the I-1-th layer,
H_{I-1}=[h_{I-1,1},h_{I-1,2}, . . . ,h_{I-1,PI-1}];
an output unit for the output layer nodes, applied to output the nodes from the output layer of the auto-encoder training network as:
Oₗ=tan h(Wₗ^{o}Hₗ+Bₗ^{o}),
wherein, W^{o}_{I}, is a weight matrix of the output layer, B^{o}_{I} is an offset vector of the output layer; the output vector O_{I}=[o_{I,1}, o_{I,2}, . . . , o_{I,PI-1}] also contains P_{I-1} values;
a first deference cost function definition unit, applied to define a deference cost function as:
$${Ψ}_{l} = \frac{1}{2 {P}_{l - 1}} {( {‖ {H}_{l - 1} - {O}_{l} ‖}_{2} )}^{2} ,$$
wherein, ∥·∥₂ represents a 2-norm of a vector difference, besides, based on I₁ standardization, defining a sparse factor as:
ρₗ=∥Hₗ∥₁;
a complete cost function definition unit, applied to define a complete cost function as:
Jₗ=Ψₗ+λρₗ,
wherein, λ is a Lagrange multiplier;
a hidden layer training unit, applied to use a back-propagation algorithm to train the values of W^{h}_{I}, B^{h}_{I}, W^{o}_{I} and B^{o}_{I}, and achieve preferred training result for hidden layers, based on the complete cost function;
a first updating unit, applied to update I=I+1, if I<L, then turn to the training network construction unit.

10. The said metabolic MS screening system based on deep learning, wherein, the said hidden layer training module includes specifically:
a second difference cost function definition unit, when supposing what the currently training is the k-th node in the output layer, the unit is applied to define the difference cost function as:
$${Ψ}_{k} = - \frac{1}{n} ( {\sum }_{n = 1}^{N} {\sum }_{s = 1}^{S} {1}_{s} ( {O}_{k}^{n} ) log \frac{exp ( {θ}_{k}^{s} {H}_{L}^{n} + {b}_{k} )}{{\sum }_{s = 1}^{S} exp ( {θ}_{k}^{S} {H}_{L}^{n} + {b}_{k} )} ) ,$$
wherein, θ^{s}ₖ is a row vector of the s-th row (s□ S) in the parameter matrix θₖ of the node k in the output layer; S=2 means a total states number expressed by the specific node; bₖ is an offset value; and the function 1ₛ( ) is an indicator function, wherein, Oⁿₖ is an output of the node k in the output layer when an input is H_{L}ⁿ, whose value is calculated as:
$${O}_{k}^{n} = {argmax}_{s ∈ S} \frac{exp ( {θ}_{k}^{s} {H}_{L}^{n} + {b}_{k} )}{{\sum }_{s = 1}^{S} exp ( {θ}_{k}^{s} {H}_{L}^{n} + {b}_{k} )} ,$$
wherein, H_{L}ⁿ is an output of the last hidden layer when it is using a sample Tₙ for training;
a norm definition unit, applied to define a sparse factor as a 1-norm of the parameter matrix:
ρₖ=Σₛ₌₁^{S}=∥θₖ^{s}∥₁,
a second complete cost function definition unit, applied to define a complete cost function as:
Jₖ=Ψₖ+λρₖ;
wherein, λ is a Lagrange multiplier;
a second updating unit, applied to update k=k+1, if k<K, then turn to the second deference cost function definition unit.
